(19) United States
(12) Patent Application Publication
(10) Pub. No.: US 2013/0183477 A1
(43) Pub. Date: Jul. 18, 2013

(54) METHOD FOR PROCESSING RAW TIMBER TO FORM FINGER-JOINTED WOOD PRODUCTS

(71) Applicants: Sebastian Leitinger, Wernersdorf (AT); Gerhard Schickhofer, Graz (AT)

(72) Inventors: Sebastian Leitinger, Wernersdorf (AT); Gerhard Schickhofer, Graz (AT)

(73) Assignee: Hans-Peter Leitinger, Wernersdorf (AT)

(21) Appl. No.: 13/820,950

(22) PCT Filed: Aug. 12, 2011
(86) PCT No.: PCT/EP11/63943

§ 371 Date: Mar. 26, 2013

(30) Foreign Application Priority Data
Sep. 7, 2010 (AT) GM 556/2010

(51) Int. Cl. B27C 9/00; B32B 7/12

(52) U.S. Cl. CPC B27C 9/00; B32B 7/12
USPC 428/58; 144/360

(57) ABSTRACT

The invention relates to a method for producing adhesively bonded wood composite products (10, 13, 24, 24a, 25a) from raw logs (1) having substantially the same raw wood length, wherein the wood composite products can be connected to form a freely selectable wood composite width and/or wood composite length, wherein substantially every raw log (1) is split in each case in the longitudinal direction into log parts (2, 20, 21) and into outer slab parts (34) and, after drying and subsequent levelling, profiling (23) is produced on opposite side surfaces (18c, 18d, 37) of each log part (2, 20, 21). After being arranged and laid alongside one another in a suitable manner, the log parts (2, 20, 21) are adhesively bonded at the side surfaces (18c, 18d, 37) to form a wood composite, wherein finger joints (11a) are produced on end sides of each wood composite over the entire width thereof, and wood composites are repeatedly adhesively bonded together at the end sides by way of the respective finger joints until a wood composite product having the selected wood composite length is obtained. Also specified are wood composite products produced by the method.

The invention relates to a method for producing adhesively bonded wood composite products from raw logs having substantially the same raw wood length, which wood composite products may be connected to form a freely selectable wood composite width and/or wood composite length. Also specified are wood composite products produced by the method.

The novel method according to the invention is intended to serve for processing harvested raw wood in an industrial scale, by means of which felled trunks from which tree top and limbs have been removed as well as preferably also strong branches that have been debarked and trimmed are further processed and utilized. The supplied round wood, for example solid wood or log timber, is to be sorted according to diameter, length and the raw wood quality and to be fed to a higher-level economical utilization by means of the method presented herein. The yield of the processing thus is to contain less low-price product components such as firewood, chopped wood, pellets, wood shavings or cellulose raw material. There is to be obtained a high yield of high-quality beams, staves and two-dimensional products formed thereof such as composite panels in order to be used as wood material, construction wood or homogenized crack-free building wood for diverse applications in the construction industries.

From prior art there is known a variety of different methods of production for the industrial processing of raw wood. Timber from round wood is currently being industrially processed in many different ways, wherein predominantly coniferous wood (spruces, pines) are further processed, thereby split into the so-called ground trunk, the middle trunk and the head section. The ground trunk is further processed into block material (boards, planks) as it is mostly free of knots, the middle trunk containing more knots is also further processed into squared wood, whereas the head section is mostly further processed into squared wood containing many knots. Parts near the top of a tree are suitable as industrial wood for the production of cellulose, and the top and the crown of a tree are suitable as firewood.

For splitting round raw wood, there are currently frequently used gang, band or chipping circular saws in diverse ways. Slab gang saws split round wood into single-stem all-wood, two-stem (centrally split) or triple-stem (having a head board) in so-called half-wood or quadruple-stem into so-called cross-wood. In this connection, there are also formed lateral boards. The multi-stem woods are prone to undesired cupping (bending-up), twisting as well as formation of crack during their drying process due to their position in the cutting plan.

Full gang saws split the trunk in a single working step into different planks and boards. Up to twenty saw blades are used in a single working step in parallel and spaced apart by the same or a different distance. For the further processing following the slab gang saws, there are used further gang saws or band saws (lateral gang saws, intermediate gang saws). Usually, the cut is performed vertically, in the case of a horizontal gang saw, it is performed horizontally. Circular saws are also used, with these being used in a single-shaft or multi-axis way and at also a variable angular position.

The best known raw logging methods are designated as follows:
1 sharp cut (parallel to the trunk in the direction of the fibre, forming untrimmed boards or planks)
2 rift cut (with cuts, partly arranged in 90°). There are to be formed as many boards having standing annual growth rings as possible.
3 semi-rift cut
4 prism cut (usually in two working steps, forming boards trimmed in parallel) squared wood (single-stem) (with chipper or four-sided splitting of lateral boards) e.g., by means of a band saw.

According to the position of a board split in the longitudinal direction of the raw wood, the parts are designated from the outside to the inside as slab (this becomes chopped wood already through the chipper), the inner log parts are designated as lateral boards, wherein the main part is usually split from the core (here: intermediate boards and intermediate planks), as well as the so-called core board, which is designated in the following also as strong intermediate plank. The core board or the intermediate plank, respectively, has a symmetrical diminishment of the annual growth rings, which is why there are not existent any substantial changes in form. In the lateral and intermediate boards the board is cupping towards its core facing side during drying. Currently, there is attempted in wood research facilities to optimize the yield and the quality of trimmed timber by non-traditional cutting methods in order to produce wood products like board-layered, beam-layered wood and plywood that are adhesively bonded in layers or cross-like and have an inhomogeneous set-up by technical drying and machine sorting. In this connection, the rift cut is of greater importance.

Finger jointed building wood having a connection according to EN 385 standards is known. A test on the basis of random samples in regard to bending strength is provided therein as sufficient self-monitoring or outside monitoring. Due to a lack of a continuous monitoring, a lacking complete reliability on the quality of the squared wood, on the rigidity sorting as well as the connection points thereof constitutes a disadvantage. This frequently and due to bad experience will result in the preference of non-finger jointed solid wood products. In the case of glued laminated wood (Glulam), finger jointed lamellas are glued together. Here, standard EN 14080 offers a rule thereto. Lamella jointing, sorting and gluing are currently only randomly examined. Gluing is also tested only randomly by delamination. The position of the annual growth rings is not taken into account in the cutting plan, which is why residual stress may cause cracks. Horn knots frequently are the reason for quality defects in the 40 mm (thin) lamellae. In the case of such wood structures, a continuous test by means of crack accumulation is economically not feasible. Pre-sorting will also only effect insignificant optimization. Joining is not possible without a great amount of material added, in particular as there has to be guaranteed for a planing of the surfaces that is suitable for gluing.

ON standard B 4125 describes the full tensile strength test of, e.g., glued laminated wood (GLT®) in particular according to ÖTZ 2008/005/6 in parallel with the fibre over the entire product length. In this way, construction solid wood having a higher reliability level under stress (reduced partial safety factor) may be produced in serial production. Disadvantageous, however, in the existing GLT® method, however, is the still not completely economical utilization of the round wood into economically more valuable products. Another disadvantage is the currently used 2 ex Log cut that is prone to formation of cracks on the side of the log parts turned away from the core (heart).

Laminated beams (BaSH) are produced like Glulam, having, however, higher wood depth, exceeding 45 mm. As flat products solid wood panels made of staves (lamellae) are known, which are glued (in continuous staves) in the longitudinal direction with dull joint. These are formed as mono-layers by selective use and orientation in press facilities. Disadvantageous are occurring cracks, deformations, cuppings and a dimension that is not 100% level.

Also three-layered solid wood panels or concrete formwork panels are known products having central and cover layers made of thin and optionally glued boards. By the cross-wise locked set-up, there is produced a flat wooden and construction material that is stable in terms of form and dimension. It is disadvantageous herein that splitting this material into smaller parts is economically not reasonable and that the parts formed thereof will obtain an undefined, highly varying and inhomogeneous quality.

Glued laminated wood BSP or also CLT (cross laminated wood) correspond to the three-layered solid wood panel; there are, however, also envisaged five- or—multi-layered set-ups. The set-up is symmetrically made of boards or also planks in sizes or widths, respectively, of up to storey-high and lengths up to currently 18 m. In this way, BSP show a high degree of pre-fabrication. The production is herein realized by parallel joining of mostly finger jointed lamellae. For the central layers there is included less expensive wood of inferior quality or sawn wood. Due to a more or less strong anisotropy of the irregular orientation and arrangement of the boards or planks, the formation of cracks in variable temperature and moisture stress, e.g., when used in buildings, is to be expected. Defects of BSP are cracks.

From prior art, e.g., DE 196 13 237, there is known the utilization of star lamellae with alternately stacked triangle columns instead of cuboid stacking of star cuts. The respective examples for growth ring positioning and arrangements of trapezoid columns are also to be found in FR 1.134.435.

A further publication on a method and devices for the profiling of trapezoid lamellae for trapezoid lamella beams is provided by EP 1 277 552.

The present invention, hence, has the task to prevent the disadvantages known from prior art.

Further tasks of the present invention are to provide a method, which economically makes use of known and already existing technologies and expressively takes into account the natural structure of the wood in order to apply the advantageous characteristics thereof in a better and more homogenized way. Due to an improved splitting of the raw wood, an optimized utilization of round wood by obtaining economical partial products or by the production of glued or jointed products, respectively, the economic efficiency of production methods used so far is to be improved. In this connection, the best quality possible in comparison to quality solid wood constitutes a matter of highest priority. Further aims of the present invention are low economical use of foreign materials (adhesives, fillers, amount of glue, energy) and optimized logistics and storage in the production and product stock formation. It is another task to guarantee by means of the method of production to be provided finger joints of the respective wood composite products that are force-fitting and fully tensile-tested. It is another aim to enable for the utilization of the raw materials up to the tree edge in quality wood application and thus to improve, apart from yield, also value creation. The novel products formed thereof are to represent an improved alternative or supplement to existing wood composite products, wherein wood composite products that are produced according to production method to be provided are to be suitable also for more demanding and sophisticated applications because of a higher reliability and improved quality due to a more uniform structure of the growth rings and the position of the branches. It is a further aim to provide such wood composite products with an attractive surface appearance (texture) and to make it possible to use such products also in the visible field (furniture, panels, interior design).

These tasks are solved in a method for producing adhesively bonded wood composite products according to the preamble of the claim 1 with the features of the characterizing part of the claim 1.

Advantageous embodiments and developments of the invention are given in the sub-claims and in the description.

Advantageous is a method according to the invention for producing adhesively bonded wood composite products from raw logs having substantially the same raw wood length, which wood composite products may be connected to form a freely selectable wood composite width and/or a freely selectable wood composite length, characterized by a sequence of the following production steps:
splitting each raw log in each case in the longitudinal direction by means of a cutting device alongside cutting planes into log parts having at least five cut surfaces, wherein there are obtained two outer slab parts as well as several inner log parts, comprising at least one intermediate plank as well as at least two intermediate planks and/or lateral boards;
preferably producing at least one relief groove by means of a cutting or milling device at the cut surfaces of one or of several inner log parts, wherein the relief groove is in each case arranged substantially orthogonally to a cut surface;
drying the inner log parts by storing in an evaporation promoting surrounding;
levelling preferably all inner log parts, wherein the log parts rest with one of the cut surfaces on a level underground or are extended across thereof and are optionally processed by way of material removal at at least one opposite cut surface to a predetermined material depth;
producing a profiling by means of a form cutting device at opposite side surfaces of each inner log part, wherein the opposite profilings are arranged preferably symmetrically to a plane of symmetry, which plane of symmetry is oriented substantially orthogonally to the cut surfaces as well as centrally of the respective material widths
preferably splitting at least one inner log part by applying a splitting cut surface extending substantially in the plane of symmetry by means of a cutting device, wherein split log parts are in each case to be positioned in a position in which they correspond to each other in pairs as well as are mutually rotated/tilted by 180°;
sorting log parts to be adhesively bonded, wherein not split log parts are arranged alongside one another in a suitable way, in particular by mutually rotating by 180° and/or by moving into tilted positions, so that in each case the planes of symmetry thereof rest substantially in parallel with one other, and/or already split log parts corresponding with each other in pairs are arranged alongside one another in a way so that the splitting cut surfaces thereof rest substantially in parallel with each other;
applying adhesives to side surfaces provided with profilings of appropriately profiled log parts having the same material depth and/or to splitting cut surfaces;
adhesively bonding the side surfaces provided with adhesive and/or the splitting cut surfaces of log parts arranged alongside one another under pressure, preferably under lateral pressure, against the surfaces provided with adhesive, into a wood composite of first quality until the selected wood composite width is exceeded, wherein the wood composite length thereof corresponds to the length of the raw wood;
optionally separating a width section of the wood composite by cutting out the width section in the longitudinal direction by means of a cutting device and adhesively bonding the remaining parts of the wood composite alongside one another along the cut surfaces formed by cutting out the width section and optionally adhesively bonding the wood composite with further log parts arranged one alongside another into a wood composite of second quality, until the selected wood composite width is again exceeded;
trimming the entire wood composite width of the wood composite in the longitudinal direction of the log parts to the selected wood composite width by means of a cutting device;
connecting the wood composite with at least one further wood composite, wherein each wood composite has a respective raw wood length and is trimmed in each case to the same wood composite width, wherein in each case following sorting or pre-chopping of unsuitable end areas there are created finger joints at end sides of each wood composite over the entire wood composite width thereof by means of finger joint milling cutters, wherein there is subsequently applied adhesive at the finger joints and wherein wood composite is repeatedly adhesively bonded to wood composite at the respective finger joints by pressing together until the selected wood composite length is exceeded and wherein the wood composite product is obtained by trimming the entire wood composite length to the selected wood composite length transversely to the longitudinal direction of the log parts.

The products or pre-products that may be produced according to the inventive method, substantially beams, girders and composite panels in level or curved embodiment, from pre-sorted round wood, are produced from manually, optically or technically determined quality and sort. The raw density, e.g., is determined by natural frequency measurements. The method may preferably be used with pure-sort round wood, it may, however, also be used with a mixture of sorts of different wood types in round wood form. In connection therewith, the length and the diameter of the round wood may be combined in the method to a big extent. In particular raw logs are split in parts having delimiting surfaces, which are substantially parallel or slightly tilted towards each other, preferably by way of cuts using gang, block band, single-shaft or multi-shaft circular saws into planks, beams and boards. The best known sawing methods and in particular the combined processing by chopping devices and following multiple sawing processes are performed in parallel with the direction of the growth axis of the tree or in the direction of the fibre growth. By means of subsequent rejoining, preferably by adhesively bonding the longitudinal sides of certain partial products in order to obtain a higher width or by finger jointing in a continuous mode of production it is possible to split off yard goods in any length, wherein the maximal length is depending on the dimensions of the plant. For finger jointing, there are selected front end sides that are free of knots or that have been freed of knots by trimming, respectively.

According to the invention and advantageously, there is formed at least a strong intermediate plank when splitting the raw log. In the cross section of the trunk this is the part, the lateral level delimiting areas of which are adjoining the growth ring core or the cross-section centre diametrically at least approximating in a fibre-parallel way. If this plank is transversely split and removed of the core, there are formed at least two intermediate beams having tangent areas that are formed at least approximately to the growth rings. The central part of a three-split intermediate plank (core) is preferably treated in a special way. Decaying wood is removed. The intermediate planks or intermediate beams are split either over the length in an as constant as possible, preferably even square, rectangular cross-section or as symmetrically trapezoid as possible cross-section and as constant external dimensions as possible preferably into a cuboid body or elongated trapezoid column body. If trapezoid columns are such separated as intermediate beams from core wood, so that the core wood forms a polygon column, e.g. with a dodecagon polygon as base area, and that a column may usefully be formed by two polygon columns, then there is obtained another quality product: round columns having an attractive texture, this is a natural knot structure with little formation of waste wood.

Additionally or alternatively and according to the invention economically, there may be formed in this method intermediate beams of a second embodiment, in particular by fibre-parallel chopping of the external surfaces of the round wood. Due to the tapering shape of round wood in the direction of the tree top of or tree crown, there are formed elongated body forms for these intermediate beams having a trapezoid-shaped radial longitudinal section. In order to obtain as constant external dimensions as possible, in each case two intermediate beams that are twisted mirror-like are adhesively bonded lengthwise in pairs with each other. For this reason, the declining sides of the first beams have to be connected with the rising sides of the second beams.

Such first wood composite products or the symmetrical planks or beams are connected tight-fittingly according to the invention via a subsequent finger joint of those products having the same end side dimensions (butt to butt).

Due to the very uniform position of growth ring cuts, finger jointing may be allowed to be performed at higher moisture levels than so far, without any known impediments due to follow-up decrease with occurring additional tensions in the fingers, in particular in the assembled state.

The secured moister adhesive bonding is optimally performed by means of a hot ridge (about 200° C.) similar to one of the fingers. Therefore, there is advantageously measured the moisture in the section to be adhesively bonded and due to a controlled reaction period the respective bonding zone is made free of moisture and sprinkled sufficiently with an adhesive. Ramifications of the adhesive as far as into the wood fibres provide for a slow and careful post-drying until the balance moisture is reached. Preferably stronger square cross-sections are adhesively bonded in a moister way according to the invention. This is of an advantage for wood such as hard wood that is dried especially slowly and complexly also with short trunks (e.g., a log length of 2.5 m). In this way, these may be used in the future rather inexpensively as construction wood.

By the inventive method formation of cracks and cupping, degree of disintegration and use of adhesives are minimized. A more favourable partial safety factor reduces the probability of failure. Planing requirements necessary so far are significantly reduced. Changes of form and dimension due to swelling or shrinkage become fewer and more regular. The position of horn knots, diagonal and round branches is more advantageous for the higher tensile strength of the products. Due to a higher surface stability of the composite panel products there are fewer complaints. Any distortions appear more advantageously than so far. By overlapping of the edge bondings between the jointed layers and the arrangement thereof, any tensions are balanced. The rigidity becomes higher and may be reliably tested by an appropriate rigidity test. The probability of finger jointed connections being released in the field due to tests performed in the fabrication plant is rather lower.

In a method according to the invention the wood composite product is usefully subjected to a rigidity test, preferably a tensile test by mutual clamping at the wood composite end sides and stressing by way of tensile stress by means of a power transmission device in the longitudinal direction of the wood composite product.

In a development of the invention the sections of the wood composite product, which have damage caused by the rigidity test, preferably by the tensile test, which are visually and/or sensorially detected and which exceed a predetermined tolerance extent, are in a method cut out and separated over the entire wood composite width transversely to the longitudinal direction, whereupon at the cut surfaces there are again arranged finger joints over the entire wood composite width as well as the remaining undamaged sections are connected at their end sides by adhesive bonding, until there is again obtained a predetermined wood composite length, wherein the rigidity test is repeated for the finished wood composite product.

After a target length dimension has been reached, the wood composite products are trimmed to a desired dimension and subjected to a rigidity test according to the invention. To this end, a tensile test in the direction of the fibre growth by way of final attack and via a hydraulic, defined tensile stress applied in a controlled way, preferably tested in pursuance with ON B 4125, is well suitable.

The section lengths for forming the intermediate planks and intermediate beams are advantageously selected so that the width thereof is smaller than or equal the thickness thereof, wherein the width is the shortest direction of expansion in a side surface, the surface normal vector of which extending at least approximately radially to the growth rings. Due to the standing structure of the growth rings, this wood is superior, of high quality, low in twists and has little proneness to crack formation or cupping. Horn knots are positioned by these cutting methods so that they do not reduce any rigidity and do not cause any fractures.

In particular in the case of suspected core cracks, it is an advantage to split the intermediate plank three times into two outer intermediate beams and one inner core beam. Then the core beam possibly having cracks may be centrally split, and the cracks may be filled with adhesives, if required. If pressing force is applied, preferably via a hydraulic or pneumatic press, preferably in parallel and via pressure onto the longitudinal side surfaces, the cracks may be closed against their direction of expansion. In this way, a core area that has so far been of rather inferior value may be better utilized.

These core beam (halves) are advantageously in parallel adhesively bonded with each other, with or at the same width dimensions, or they are subjected to a rigidity test as partly adhesively bonded or not adhesively bonded mono-layer. This test is preferably carried out before the formation of panels by way of a multi-axis tensile test facility, wherein at least two parallel gripers grip at both end-grained ends and wherein clamping jaws having a wood protecting profile are used.

The tensile test of the composite panels or in parallel of several staves, which is made possible by this method, carried out (before and/or after) the splitting simultaneously by stretch measurement and by the determination of the E-module is usually supplemented by recording of the measurement. Measurement of the developing structure-bone sound waves (acoustic) may provide additional information and knowledge on the quality course within the staves and the composite panel. All these pieces of information may be used for optimizing the subsequent sorting, further processing and resplitting measures. Equally, several layers of tensile-tested composite panels may be adhesively bonded together into multi-layered and/or multi-ply wood.

The substantial production steps of this method according to the invention are, apart from optimal pre-sorting of the raw logs using especially efficient methods of non-destructive testing (NDT) like natural frequency measurement, X-rays, optical or optosensorial, resp., recording, image processing and the like:
New systematic splitting of the material on the basis of an elaborated yield-optimized splitting plan, in particular on the basis of an optimized cutting and trimming plan (including profiling) for the further processing into crack-free continuous quality beams and continuous quality panels in consideration of the growth and branch structure.
Adhesive bonding of the individual parts after splitting into continuous products having a defined width, taking into account the position of the growth rings, using of finger jointing also beyond known widths.
Optionally testing each wood composite product thus produced after cutting to a test dimension, wherein substantially, apart from the finger jointed connection points in the direction of the fibres there are rather early detected weak points in the basic material and wherein the rigidity is determined via the elasticity module, preferably by means of a tensile strength test.

In an embodiment variant of the method according to the invention, there is performed a cut for splitting raw logs into log parts along parallel cutting planes, which are substantially in parallel with the longitudinal axis of the raw wood, wherein in each case the cut surfaces of the log parts are in parallel with one other.

In a further advantageous embodiment variant of the invention, there is performed in a method a cut for splitting raw logs into log parts along cutting planes, which are substantially in parallel with one of two tangent planes that are diametrically opposite to each other at the conically tapering round wood external surface, wherein the round wood is split, by a first cut in first cutting planes in parallel with the first tangent plane, starting at the outside, into log parts having cut surfaces that are in parallel with one another up to an intermediate plank, as well wherein the round wood is split by a second cut in second cutting planes in parallel with a second tangent plane that is diametric to a first tangent plane, starting again from the outside, into log parts having cut surfaces that are in parallel with each other up to an intermediate plank, by means of which there is obtained a tapering, wedge-like intermediate plank.

In this embodiment log parts are cut in parallel with the shell in each case in parallel with diametric tangent planes at the round wood trunk section. There is obtained a central, approximately wedge-like intermediate plank. This cut line offers the advantage that weakening branch sections are accommodated by the log parts that are nearly naturally cut in parallel with the shell, thus having as few weak points as possible. The weakening core zone of the wood is accommodated by the intermediate plank and may subsequently be separated simply as core wood section from the intermediate plank or the intermediate plank parts thereof, respectively, offering a further advantage of this cutting line.

Especially advantageously, in a method according to the invention the tapering, wedge-like intermediate plank is split in the longitudinal direction along cutting planes, in each case in parallel with the cut surfaces thereof, by cutting out and separating at least one central, substantially pyramid-frustum-shaped core wood section into two substantially wedge-like intermediate plank parts, whereupon the two corresponding intermediate plank parts are each positioned in a position in which they correspond with each other as well as are mutually twisted by 180° and/or tilted and are each adhesively bonded with each other flatly at the cut surfaces into a composite wood product.

In an advantageous variant of the invention, in a method for the inner log parts the profilings are embodied in the foam of two oblique, level surfaces that are substantially symmetrical to the plane of symmetry, which are in each case defined in an opening angle in regard to the split cut surfaces in their position, wherein the opening angles of the profilings are selected as close to the perimeter of the round wood external surface as possible and wherein the profilings are formed either by a surface section formed orthogonally to the cutting lines in a longitudinal butt or by two surface sections at the side edges, which are formed orthogonally to the cutting lines, wherein the profilings are produced by means of machining tools, preferably by pulling end side cutters or by three rotating circular saw blades.

The profilings are usually provided with an substantially constant profile form at the side surfaces of the log parts along the entire log length.

In a method according to the invention in the case of a core defect, for example decaying wood, a hollow trunk or a core crack in the raw log there is split at least an inner log part into in each case two log parts that are corresponding with each other, wherein there is produced a core-sided profiling by means of a form cutting device at an inner side of each split log part, wherein this core-sided profiling is carried out as close to such core defects as possible so that corresponding log parts are supplemented with their outer profiling or their core-sided profiling as fittingly as possible over the length and in their width at the respective position.

Advantageously in a method according to the invention several different inner log parts from raw logs in parallel arrangement to each other and/or adhesively bonded with each other and/or partly adhesively bonded with each other and/or as not adhesively bonded individual parts are in each case subjected to a rigidity test, preferably a rigidity test for panel-shaped adhesively bonded wood composite products, wherein a tensile test facility comprising at least two parallel gripers, which are arranged at one or several hydraulic test heads as well as at two grain-ended ends of all parallel log parts, may be positioned in a mono-layer, wherein the gripers are provided with clamping jaws having a wood protecting clamp profile.

In a further development of the invention several layers of wood composite products, preferably having the same wood composite lengths and the same wood composite widths, are adhesively bonded stacked upon each other to form a multi-layered wood.

In a method according to the invention at least two wood composite products are usefully bent and are connected with each other to form bent multi-layered panels, in particular semi-circular parts, in parallel or flatly off-set, preferably adhesively bonded with each other

The invention further relates to a wood composite product, wherein several log parts are adhesively bonded to a mono-layered composite panel at the cut surfaces facing the core and the cut surfaces thereof turned away from the core or at the profile areas or cut surface areas, respectively, wherein the remaining not adhesively bonded side surfaces form the outer main surfaces of the mono-layered composite panel.

A wood composite product according to the invention usefully comprises log parts in particular intermediate planks, intermediate boards or lateral boards having a constant length, which are connected to a wood composite width with the same material depth, wherein the connected log parts have square or rectangular cut surface sections at their connecting surfaces, wherein there are visible at the main surfaces of end surfaces of the wood composite product oblique butt joints and/or butt-jointed components having a symmetrical trapezoid form or having a rectangular, if required also bent, trapezoid form.

In a further development of the invention a wood composite product has least one finger jointed connection running over the entire wood composite width, transversely to a fibre direction.

In a wood composite product according to the invention internal panel layers made of several mono-layered composite panels are made of log parts having a lower-quality appearance than the visible external panel layers, wherein hollow spaces in the multi-layered panels are optionally filled with lower-quality wood ingredients and/or with non-wood ingredients.

In a wood composite product desired crack chamfers are advantageously arranged at a visible side of a composite panel and guiding chamfers as power deflection recesses for accommodating tensile changes on an opposite side facing the visible side.

In particular the invention relates to stave-shaped products like single-stave-beams (continuous production) or multi-layered beams, which are composed of individual beams that are suitably adhesively bonded with each other. Furthermore the invention includes mono- or multi-layered panel-like products, which are composed of log parts having the depth of boards or planks and being adhesively bonded in parallel, not in a right angle and which show general finger joints running over the entire panel width. The joint course thus formed confers to the composite panel products a characterization of their own.

These products are systematically produced and are intended as insertion staves mostly as girder components, in particular as mono- or multi-layered beams and planks. They further have diverse forms of application as boards and composite panels in supporting and non-supporting constructions of the building industry, e.g., as construction wood in the framework construction, half-wooded construction for formworks, wall panels, walls, but also in furniture and panels.

In addition to the core beams and central beams of the central plank there is provided according to the invention to produce at least two intermediate planks or intermediate boards and at least two lateral boards by means of splitting, wherein the lateral boards represent the outmost round log parts having the youngest lying growth rings and mostly point-shaped or round branches. The intermediate planks or intermediate boards have in partly sharp cut, partly semi- or rift-cut way predominantly semi-standing, and approximately uniform growth ring segments in cross-section.

A substantial feature according to the invention is a trimming of the intermediate planks that is adapted to the external surface of the round wood (form) as well as of the intermediate and lateral boards in the form of a waste-free profiling that is suitable for adhesive bonding. This may be realized, e.g., by three circular saws in sequence, but also by automated measurement (e.g., by image processing, light intersection process and the like) and automated orientation. The resulting profiles are suitable for longitudinal jointing and adhesive bonding. These are preferably formed having a straight or transverse longitudinal butt, but substantially having edges at an angle to the surface. Shaping these surfaces for sheet bonding as tanner sheet or obliquely is especially advantageous. These boards and intermediate planks are pre-sorted—according to same length and same depth. Via the same lengthwise profiling and via alternately tilted and non-tiled position, there is realized a lengthwise joining and adhesive bonding of the boards or planks, respectively, thus balancing the conicity given due to any tapering in the growth direction of a trunk.

Before joining into a composite panel, the planks or boards, respectively, are sorted and stored for exchange of moisture. Subsequently, they are individually, either complete or centrally split, folded at each second part and then adhesively bonded to the first one via the profiling. In this way, there are formed parallel, two-part boards or double-boards. These are then also immediately jointed into a composite panel and later on adjusted to the target width by splitting.

In this way, there are formed panel-like products having a defined width and depth, which obtain due to the same length over the panel width at both length ends fingers, wherein fingers and recesses of the one end are formed so that they fittingly supplement those of the other end.

Possible defects and branches, which are unsuitable for jointing, may be advantageously removed by trimming the boards, planks, over the entire panel width in order to obtain a possibly branch-free joint area. The fingers are intended to create a continuous expansion with further composite panels having the same width and depth. On the basis of the general finger jointing there is formed a continuous composite panel, from which starting at the foremost end composite panels having the desired target lengths may be trimmed.

For the finished composite panels there is advantageously used a rigidity test, which is performed in the form of a tensile test over the entire surface of a composite panel, in particular of an adhesively bonded layer formed according to the invention. This quality assurance is of advantage especially for cover layers. To this end, there is applied a testing tensile force at at least two regions, preferably in two test axes in parallel with the fibre direction at both on the side of the end-grained wood. Griping means having clamping jaws are intended to fix and tense the composite plane preferably hydraulically. During a defined period of time in which the test tension is kept, the E-module is measured through elongation, and changes in the wood due to the delivery of test tension are preferably recorded.

Movable, entailing clamping jaws having a controllable (hydraulic) pressing power control are preferably used already for the used boards and planks during pre-sorting or pre-testing. These pre-tests are efficiently carried out in a transverse through-put procedure. There may also be detected any slip, which is why a required pressure may be enhanced. The elongation path of the boards and planks to be tested is preferably increasing to about 2 to 5 mm, max. 10 mm in the direction of the power supply. The E-module of the composite panels is preferably determined for sorting especially for the use as cover layers.

Intermediate planks or intermediate boards and lateral boards formed by sharp cut advantageously are provided according to the invention in the longitudinal direction in the freshly cut state with a relief groove, centrally on the width side of the core side. Upon drying the symmetrical edge profiling of the round wood edge areas is realized.

Before they are adhesively bonded to form the panel width, these intermediate planks, intermediate boards or lateral boards formed by sharp cut are centrally split using a straight cut, for example having a higher cutting width, in particular having a cutting width of 4-5 mm. This is preferably carried out in the tension relief groove, which gets a lower, preferably 2-3 mm wide cut width. Then in each case one half is tilted and adhesively bonded to the opposite second narrow length side of the second half, which is why the two not-cuboid board or plank halves form a cube. If the central part (core) of the board is interspersed with decaying wood and, hence, useless, this may either be cut away by a straight cut or favourably according to the invention also by the formation of a suitable profile that supplements the edge profiling, suitable for the formation of flat panels. These boards are also favourably tested in the transverse through-put procedure.

Thus formed composite panels may be split simply be new splitting, preferably by sawing, into smaller products, also stave- or plank- or board-like products. This simplifies storage of the material for the most diverse product requests, as target products may be produced by final splitting immediately before delivery.

It is useful to connect at least two such formed composite panels into multi-layered panels. These are therefore adhesively bonded. A crosswise position of the panels (twisted to each other by 90°) is advantageous. Hollow spaces with special filling, such as, e.g., flame-retardants and the like, or air between the layers may be advantageously formed by the arrangement of the panels in order to obtain in such a way optimized thermal characteristics, insulation characteristics or flame-retardant characteristics of the panels.

The adhesive bonding areas may be embodied in a significantly reduced way by means of grooved areas in parallel with the fibre direction or also by cross-wise adhesive bonding.

In order to form crack-free visible surfaces, discrete desired crack chamfers are formed in the joint area of the visible surfaces. By shaping by means of defined dimensions of width, depth and form of the grooved chamfers or grooves or by power deflecting via selecting the distances of the adhesive fibres as well as the distances of the grooves, in particular where applied adhesive does not adhere, tensions in the visible surface are deflected into the desired crack chamfers. There, hardly visible cracks or such not visible at all may release the tensions, without impeding the visible surfaces.

Wood types having little raw density differences between trunk wood and branch wood may be connected according to the invention already by means of rough sawn flat adhesive bonding already with an appropriate jointing partner, preferably after excess depth has been removed for levelling.

If at least two composite panels thus formed are bent or are adhesively bonded into bent multi-layered panels, this connection will retain the bending. In this way, it is rather simple to produce semi-circular parts or bent parts thereof. Adhesive bonding may also be realized by means of bent composite panels that are displaced relative to each other.

A cylindrical curvature of a support area that is concave or convey may be advantageously used for bending in the adhesive panel bonding.

Apart from these method characteristics according to the invention, tested wood composite product, in particular rigidity tested ones, are part of the application of the invention. These products are composed of intermediate planks or intermediate beams of variable length. In this way, they are given new plank lengths and an at least approximately equivalent growth ring segment orientation at the end-side finger jointed connections. The wood composite product has dimensions, the width of which is smaller than or equal the depth thereof. The wood composite product or wood composite intermediate product has preferably a ratio depth:width between 2:1 and 5:4, in particular between 3:2 and 4:3.

Using the intermediate beams in multi-layered beams made of intermediate planks that are composed of side surfaces arranged in pairs turned away from the core and have the same length is considered advantageous, wherein there are formed at least approximate cubes, wherein the forming intermediate planks represent rectangular trapezoid columns in the expansion direction of the plank width.

A further tested wood composite product is a multi-layered beam made of at least two centrally split core beams. The core beam halves are adhesively bonded at least in approximately the same growth ring segment orientation lengthwise in parallel with each other. The core side of each core beam half is therefore oriented in the same direction. Therein, the side surface, which is turned away from the core, of the one core beam half is adhesively bonded with the other core side of the other one.

The dimensions have a width smaller than or equivalent to the depth of the wood composite product. This ratio depth:width is preferably within 2:1 and 5:4, in particular within 3:2 and 4:3.

Cracks in the core beam halves on the side of the core are advantageously filled with adhesives and closed due to a pressing device.

Several beams or multi-layered beams are adhesively bonded with each other at the side surfaces thereof. In order to compensate for bends and asymmetries, these beams are adhesively bonded in an alternating growth ring position. In this way, the side facing the core and the side of the planks turned away from the core form in parallel and alternately a mono-layered composite panel that is preferably level or slightly undulating due to rifts.

An advantageous connection form of intermediate planks, intermediate boards or lateral boards having a constant length and the same width in regard to a desire panel width is composed of only two sides having a square or a rectangular cut surface.

The intermediate planks, intermediate boards or lateral boards usefully have edge-profiled side surfaces or split cut surfaces due to sharp cutting. These surfaces are adhesively bonded in an at least approximately unidirectional growth ring position. The composite panel furthermore shows, in variable distances conditioned by production, a general finger jointed connection running over the entire plane width transversely to the fibre direction.

Each component of such composite panels may advantageously have at least two sides, which show an at least approximately trapezoid cut surface.

The composite panel may have bends or curvatures. Several composite panels may usefully be put together to form a multi-layered panel.

The multi-layered panels according to the invention may be advantageously twisted in regard to each other in regard to their fibre direction, and they may further be adhesively bonded, preferably in a cross-wise stacking with 90° twist of the fibre direction of neighbouring large-scale surfaces.

Advantageously, the higher-quality and optically more attractive wood parts may be used for the external and visible panels. For the intermediate layers, there are also used wood ingredients that are less valuable. Latter may also be used for filling hollow spaces of the multi-layered panels.

The composite panels are provided at the visible surface thereof with desired crack chamfers in order to deflect tensions selectively and as inconspicuously as possible. At the rear sides thereof are provided guiding chamfers.

In this way there are obtained stave-like intermediate products from round wood splitting. Squared wood thereof having a nearly symmetrical growth ring sector position are finger jointedly arranged continuously next to each other at the end sides, according to requirements these are trimmed and optionally tested in regard to rigidity. Lengthwise adhesive bonding into layered squared wood, also by means of size compensation, is also possible. Further intermediate products of this splitting are cut off-centrally of the round wood cross-section: intermediate planks and boards. At the external surfaces of the tree these intermediate products are trimmed approximating the contour by producing a profiling. In this way, these are given trapezoid cross-sections due to original position and orientation, the width dimension thereof is tapering in the direction of the upper tree part. By adhesively bonding such intermediate products of the same length and the same depth, in pairs and annulling thus conicity, in a twisted way, it is possible to produce a composite panel having defined dimensions. The panel pieces thus obtained are extended via general finger jointed connections to form continuous composite panels, according to the requirements these are trimmed, subsequently preferably tested in regard to rigidity and sometimes subsequently even further processed by multi-layered adhesive bonding or new splitting.

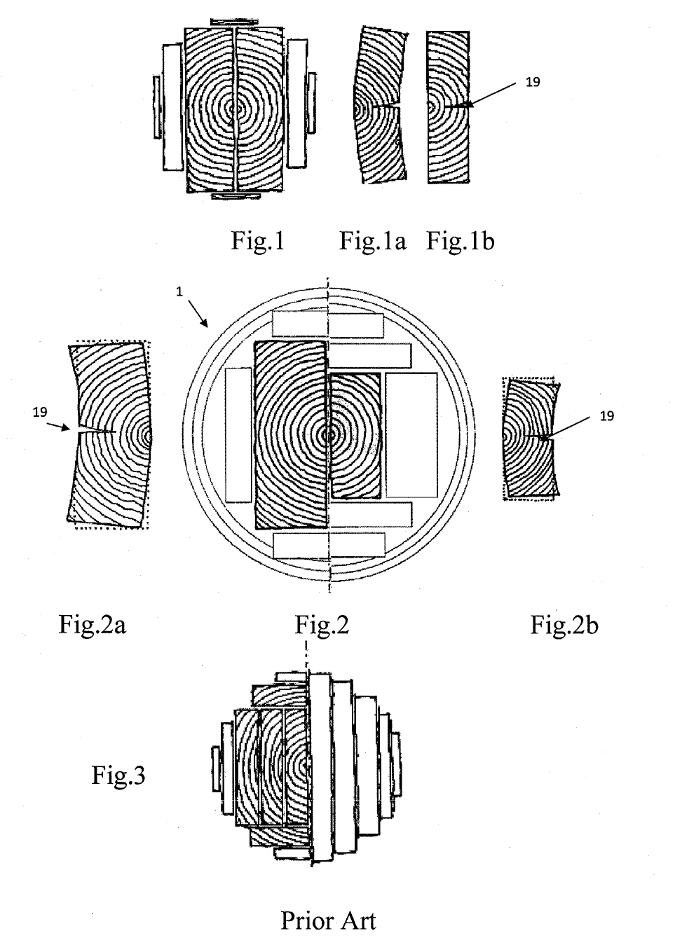

Further features of the invention become obvious from the following description of exemplary embodiments and in consideration of the schematic drawings, wherein FIGS. 1 to 3 relate to known prior art.

FIG. 1 and FIG. 2 each show images cross-sections of round log cuts having growth rings (annular rings);

FIG. 1b and FIG. 1a are partial views of the beams before and after the drying process;

FIG. 3 is a prism formation and a sharp cut (without wane utilization);

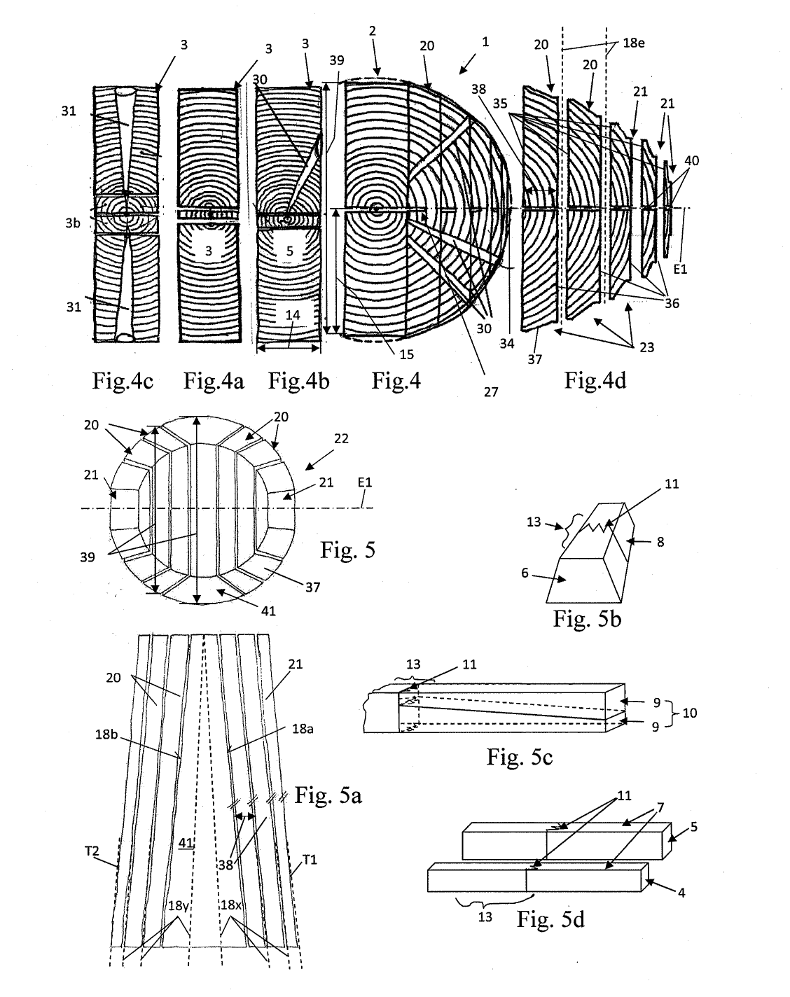

FIG. 4 is a section of a first split according to the invention, in view with a relief groove with the variants of a core-split intermediate plank;

FIG. 4a, FIG. 4b show a core-removed splitting, and in FIG. 4b diagonal branches are shown;

FIG. 4c shows a core wood separated split;

FIG. 4d shows cut intermediate planks and lateral boards;

FIG. 5 shows a further embodiment of a cutting according to the invention in a top view;

FIG. 5a shows the cut line depicted in FIG. 5 in a lateral view in the longitudinal direction;

FIG. 5b shows an elongated trapezoid column having a trapezoid cross-section;

FIG. 5c shows two trapezoid short columns (in the width direction) jointed to a cube as a first wood composite product;

FIG. 5d shows a cube, a rectangular prism and a prism having a square base, which each have been jointed into a wood composite product;

FIG. 6 shows a sharp cut with intermediate plank without lateral board, an intermediate plank with included annular ring position; a further intermediate plank and two lateral boards, each showing profiling examples;

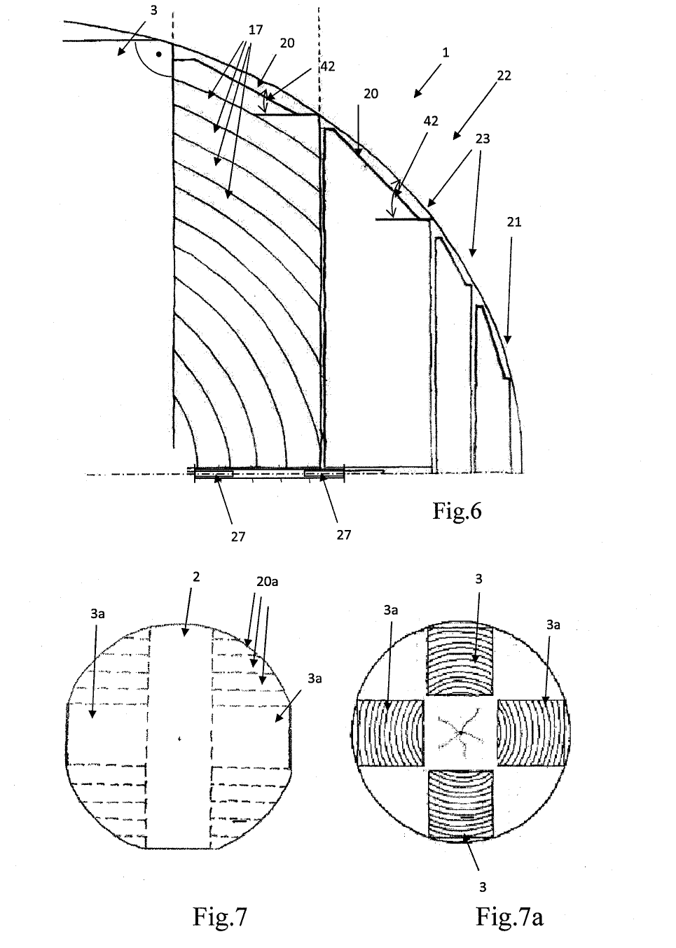

FIG. 7 and FIG. 7a each show a further embodiment of a splitting according to the invention in the sectional view with production of four intermediate beams, in particular in the case of core-cracked wood (FIG. 7a);

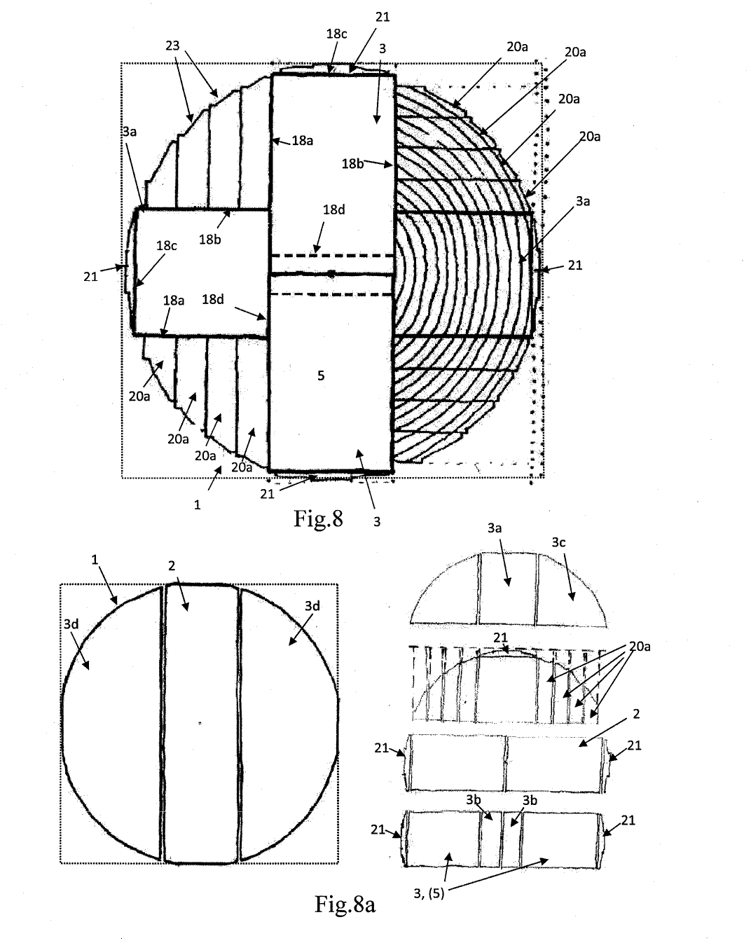

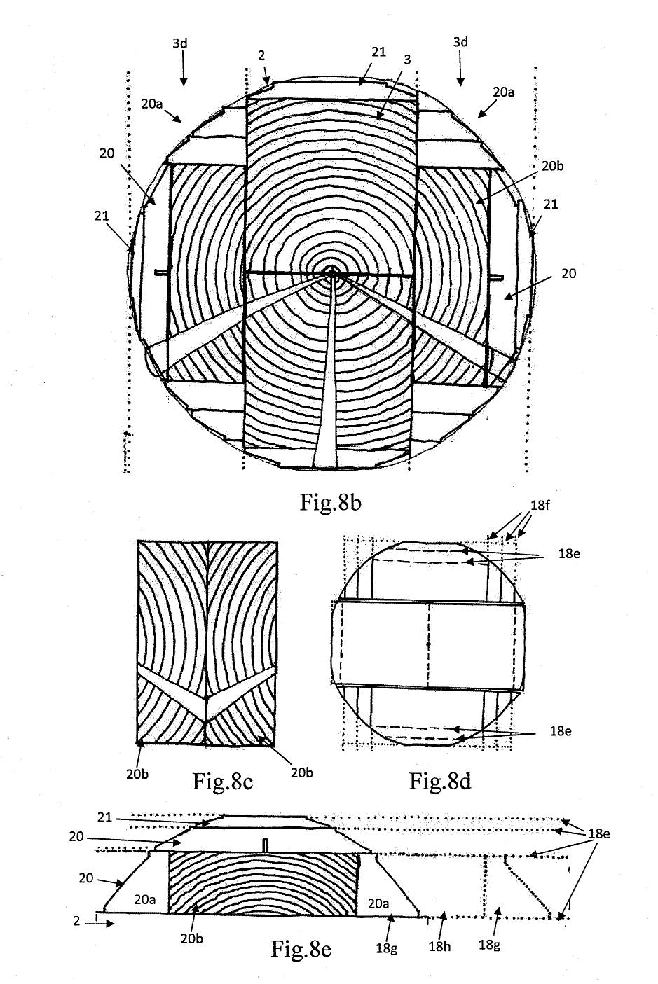

FIG. 8 shows an splitting of a further embodiment;

FIG. 8a shows the individual steps of an especially favourable splitting according to the invention;

FIG. 8b shows a further splitting into two intermediate beams and two intermediate beams having nearly standing annular rings without core area;

FIG. 8c shows a profile of adhesively bonded GLT duo-girders;

FIG. 8d shows splitting into intermediate beams and mountings, wherein these are split into intermediate beams and intermediate planks without core area as well as subsequently into intermediate planks and lateral boards;

FIG. 8e shows a further reasonable splitting into intermediate plank, intermediate beam and intermediate planks, profiled without core areas, wherein the intermediate plank has a relief groove and the intermediate plank and one lateral board are in each case profiled;

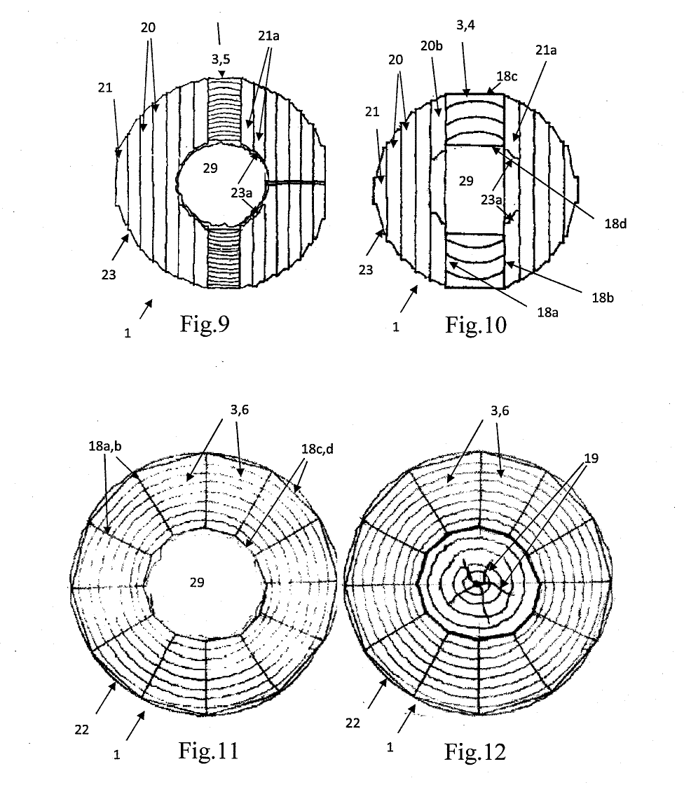

FIG. 9, FIG. 10 and FIG. 11 each show splittings of the round wood in the case of core decaying or wood types with unsuitable or useless, respectively, core wood regions;

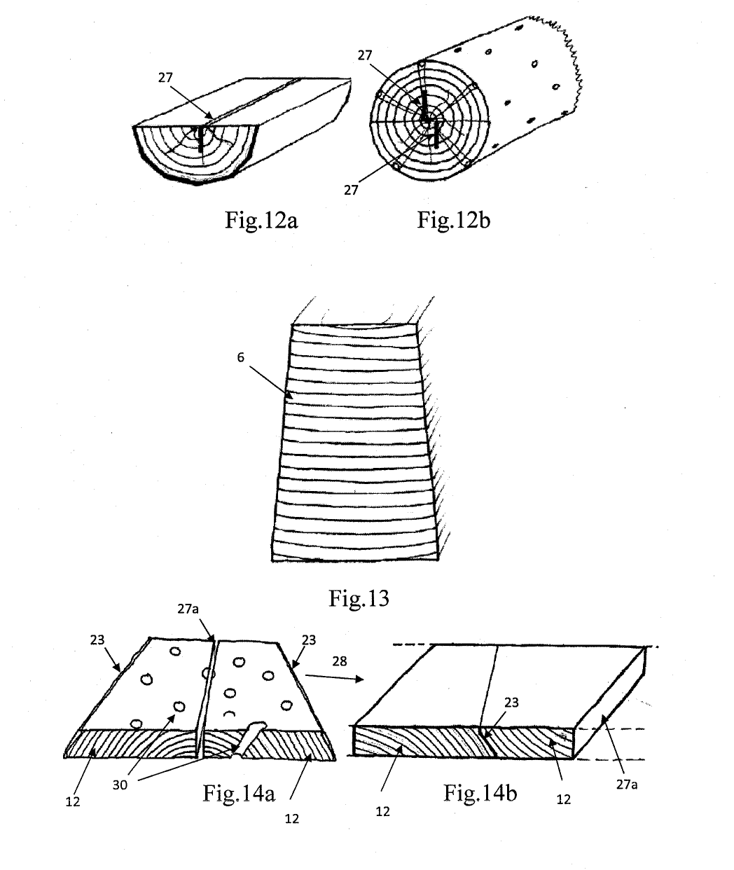

FIG. 12 shows a similar splitting as in FIG. 11, with intact healthy or torn core wood;

FIG. 12a and FIG. 12b show the use of core wood for the interesting alternative formation of a column;

FIG. 13 shows an intermediate beam cross-section with conicity corresponding to the splittings of FIG. 11 and FIG. 12;

FIG. 14a, FIG. 14b each show views of a plank or a board according to the invention having been tripped to the tree edge, constant depth and a conical course due to the tree tapering before and after tilting or folding, respectively, and consequent connection positioning again in parallel;

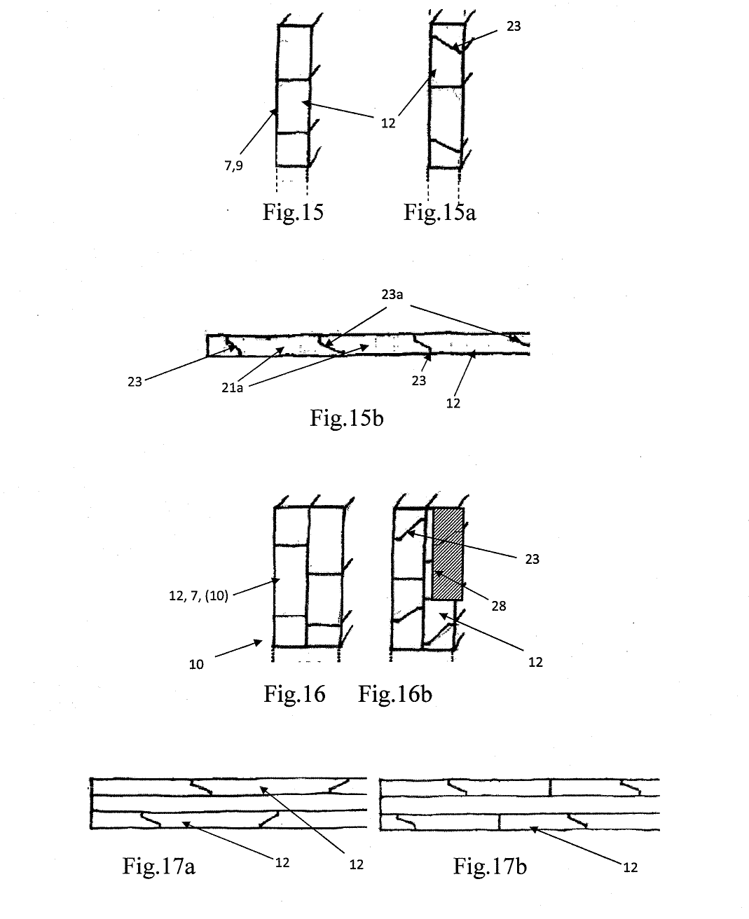

FIG. 15 to FIG. 17 each show in sectional views of the planks/board joints different wood composite products orthogonally to the fibre direction;

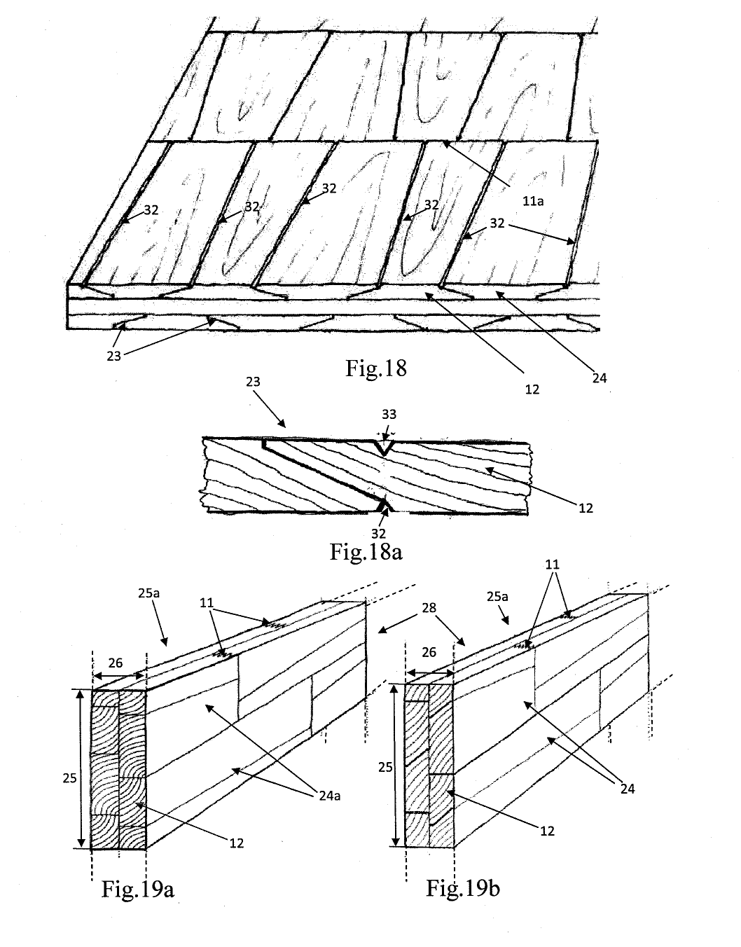

FIG. 18 shows a typical surface view of an embodiment according to a panel-like wood composite product, similar to FIG. 17a, having desired crack chamfers at the panel side;

FIG. 18a shows possible chamfers in the joint region as desired crack chamfers on the cover or visible surface of a composite panel;

FIG. 19a and FIG. 19b each show two-layer-girders in different butt connection, in an embodiment without general finger joint butt, wherein the finger jointed and tensile-tested staves are adhesively bonded to form the composite panel as well produced from trapezoid split intermediate planks that are adhesively bonded in a smooth and profiled way;

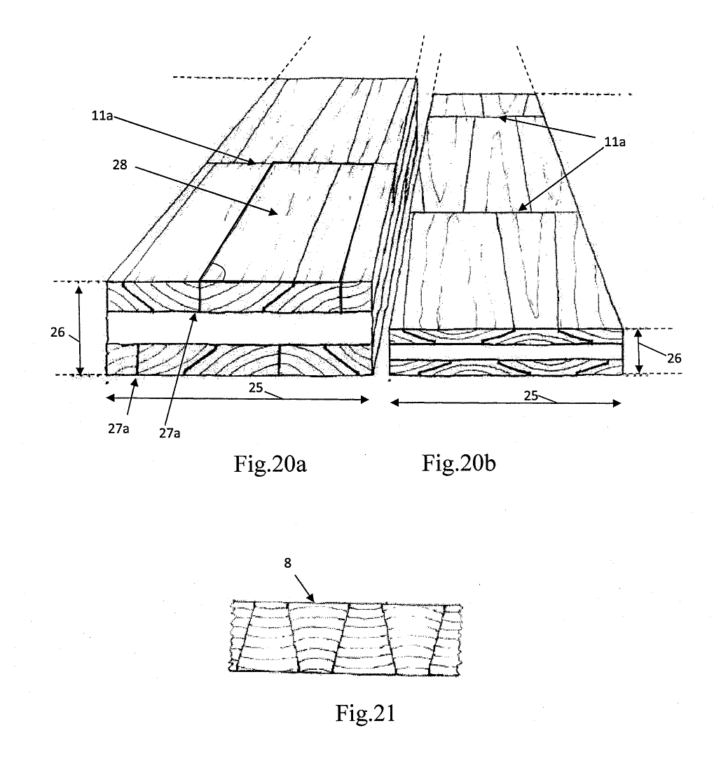

FIG. 20a and FIG. 20b each show three-layered elements, which are separated as width sections already from a multi-layered composite panel, in different butt connection or in different surface image, respectively, wherein;

FIG. 20a represents centrally split profiled lateral boards and

FIG. 20b shows trapezoid-like profiled lateral boards, which are adhesively bonded turned around, which are trimmed and arranged in a cross-wise arrangement;

FIG. 21 shows a panel connection with trapezoid columns in inventive single stave-tested jointing or general finger jointing over the entire panel width;

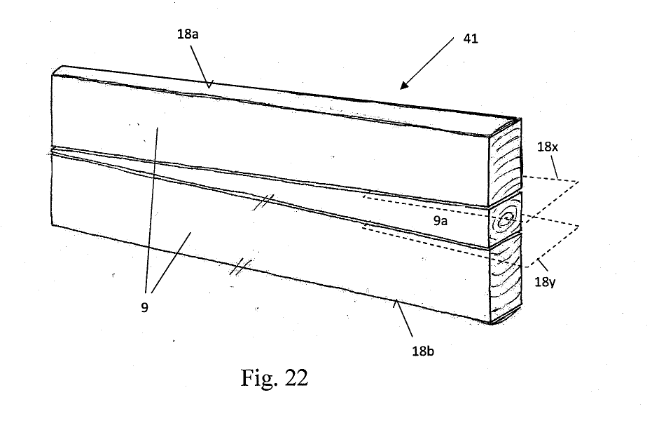

FIG. 22 shows in a view from above a substantially wedge-like intermediate plank, which may be split into intermediate plank parts as well as an intermediate core wood section.

The FIGS. 1 to 3 relate to splittings of raw log 1, which have been known from prior art. FIG. 1 shows a typical cut profile of a round log generated by slab gang saws in a parallel cut having different blade saw distances and a blunt rectangular trimming. By further drying the thus obtained beams and boards having high anisotropy due to the position of the annular rings, there are developed deformation and cracks, a profile of the two main planks shows partly halved annular growth rings causing the unilateral tension. FIG. 1a and FIG. 1b show the changes of the right plank depicted in FIG. 1.

Many wood processing companies focus on the cut plans according to FIG. 2. This so-called 2 ex Log cut is oriented at the conditions of the round log and shall provide two to four possibly large planks, starting with a step of halving and subsequently splitting the main planks and finally obtaining less qualitative by-material. Also herein, a strong proneness to crack formation and cupping occurs during drying, which is disadvantageous for the core-split planks.

FIG. 3 shows two main cutting types, which are herein depicted together by way of a round log. The left half in FIG. 3 shows a prism cut with planks, for lamellae useable for BSH and the lateral boards. The right half in FIG. 3 shows a sharp cut that has just been trimmed. None of the boards has standing growth rings over the entire end side. The growth ring sections, hence, are present extending over the longer dimension of the boards. Also herein, anisotropy is disadvantageous for the form stability of the boards and planks. The straight cuts at the tree edge in addition destroy valuable log parts, so that, apart from not optimal quality, also a possible yield is incompletely utilized and exploited.

FIG. 4, FIG. 5 and FIG. 6 show basic cut form that are important for the method according to the invention, such as the round log 1 may be split into an intermediate plank 2 and into the lateral material comprising intermediate planks 20 and intermediate boards as well as lateral boards 21 as well as into outer slab parts 34. The so-called tree edge at a round log external surface 22 of the side material is refined by a profiling 23 at the side surfaces 37 thereof. The intermediate plank 2 having a material width 39 is centrally split (core-split) into intermediate beams 3, which each have a rectangular cross-section 5 having a depth 15 and a width 14. The core region may, as is shown in FIG. 4a and FIG. 4b, be cut out. In FIG. 4c there is depicted that the core region may also be used as an individual core-separated core beam 3b. Horn knots 31 or diagonal or point-shaped, resp., branches 30 represent in comparison only a rather low rigidity decrease in the product. The cut line of the log parts in FIG. 4d is realized in each case in cut surfaces 18e that are in parallel with each other, which run substantially orthogonally to a plane of symmetry E1. The log parts 20, 21 thus get core-facing cut surfaces 35 as well as cut surfaces 36 that are turned away from the core. A material depth 38 of the log parts 2, 20, 21 may be varied according to the cross-section of the round log.

FIG. 4d shows split, centrally split intermediate planks 20, intermediate bards and lateral boards 21 along a splitting cut surface 40.

By applying a relief groove 27, as depicted in FIG. 4, which is herein substantially arranged in the plane of symmetry E1, the intermediate plank 20 becomes free of any tension.

FIG. 5 shows a further embodiment of an inventive splitting in a top view in the direction of the longitudinal axis of the log. The conically tapering cross-section of the round log external surface 22 is clearly recognizable. FIG. 5a shows the splitting line depicted in FIG. 5 in a side view in the longitudinal direction of the log wood trunk.

The one cut line for splitting the raw log 1 into log parts 20, 21 is carried along cutting planes 18x, 18y, which are substantially in parallel with one of two tangent planes T1, T2 that are diametrically opposite to each other at the conically tapering round wood external surface 22. The raw wood 1 is split, by a first cut in first cutting planes 18x in parallel with the first tangent plane T1, starting from the outside, into log parts 20, 21 having cut surfaces 35, 36 that are in parallel with one another up to an intermediate plank 41, as well as by a second cut in second cutting planes 18y in parallel with a second tangent plane T2 that is diametric to a first tangent plane T1, starting again from the outside, into log parts 20, 21 having cut surfaces 35, 36 that are in parallel with each other, up to the intermediate plank 41. The cut lines in the cutting planes 18x und 18y may be carried one after the other or rather simultaneously. By this splitting there is obtained a tapering, wedge-like intermediate plank 41.

A tapering wedge-like intermediate plank 41, as is obtained through a cutting line depicted in FIG. 5 or FIG. 5a, respectively, is illustrated in the following FIG. 22 in a view from above. The intermediate plank 41 is split in the direction of the longitudinal axis alongside of cutting planes 18x, 18y in each case in parallel with the cut surfaces 18a, 18b thereof by cutting and separating at least one intermediate, substantially pyramid-frustum-like core wood section 9a into two substantially wedge-like intermediate plank parts 9. The cutting planes 18x und 18y for cutting out a central core wood section are visible in the FIGS. 5a and 22.

The two corresponding intermediate plank parts 9 thus obtained may then be positioned, as is illustrated in FIG. 5c, into a position in which they correspond with each other as well as are twisted by 180° and/or tilted and are each adhesively bonded flatly at the cut surfaces 18a, 18b with each other to form a composite wood product 10.

FIG. 5b shows an elongated trapezoid column body having a trapezoid cross-section. FIG. 5d shows two cubes, a rectangular prism and a prism having a square base, which are in each case jointed to form a wood composite product.

In FIG. 6 there is shown a quarter round log in a cross-sectional view, with the growth rings 17 being here only indicated for an intermediate plank. The round log edge zone is profiled with profiling 23 at the so-called tree edge, this is the round log external surface 22. These profilings, which each have different opening angles 42, are required for butt jointing the oblique longitudinal butts with blunt sections. This so-called sheet connection is formed, e.g., as a tanner sheet-like joint surface.

FIG. 7 and FIG. 7a each show a possibility to obtain also four intermediate beams 3, 3a having a square cross-section 4, wherein the intermediate plank 2 may be further split, as described above, or it is nearly split in thirds due to the assumption of cracks, as in FIG. 7a. The intermediate beam is the core beam, and this may be centrally split, similar to that shown in FIG. 4c, wherein subsequently there is introduced an adhesive into the core cracks, and the core halves are again closed by pressing. The arrangement of the core beam halves is carried out not by jointing at the splitting surface but rather according to the invention. As is visible from FIG. 7, intermediate planks may be formed as residue planks or residue boards 20 without core region herein from the residual areas remaining diagonally to the intermediate beams by means of cutting and may then be further processed.

FIG. 8 illustrates that the intermediate planks 20a without core region may be selected in the cutting plan horizontally as well as vertically in order to take into account the conditions of the round wood according to the requirements and in view of a better yield. In addition, the side surfaces 18a, 18b of each intermediate beam 3, 3a are situated in parallel. FIG. 8a shows a possible cut line. Firstly, the round wood is split into thirds by the slab gang saw or machining tool and multiple-band saws, thus forming the intermediate plank 2 in sharp cut. The two side parts, mountings 3d are again split into thirds, twisted by 90°, thus forming the further intermediate beams 3a. Simultaneously or subsequently, the lateral boards 21 and the intermediate boards or intermediate planks without core region 20a may be developed. The intermediate plank 2 is then core-split or core-removed, and any outer lateral boards 21 are then cut off.

FIG. 8b and FIG. 8d show that intermediate planks 20b without core region are further split on the left and right of the intermediate plank 2f from the two mountings 3d.

FIG. 8c shows two intermediate planks 20b that are adhesively bonded to form a GLT duo-beam.

FIG. 8e shows how splitting is carried out, by means of maximal yield exploitation, and subsequent splitting into an intermediate plank 2, intermediate beams 20b, intermediate planks 20a, 20 and lateral boards 21 along the cutting lines 18e. The connection further has a trapezoid form (in particular the intermediate planks 20a without core region), wherein the conicity is used and profiled parts 18g with 18h and further 18g and 18h that are alternately turned are adhesively bonded in a profile view.

In the case of wood 29 having a soft or decaying core, as is shown in FIG. 9 to FIG. 11, the core wood is removed, and the remaining material is then in correspondence with the tree-side profilings 23 also profiled at the side of the core 21a, wherein only wood regions of high quality remain in order to form the lateral boards and intermediate boards 21, 20. Splitting is carried out according to the diameter of the round log and according to the characteristics into two to four intermediate beams having a square to rectangular cross-section.

The cutting forms in FIG. 11 and FIG. 12 constitute a special feature. Here are formed so-called trapezoid columns, which are also used as intermediate beams. In FIG. 11 there is removed a soft or decaying core 29. In FIG. 12 there is formed a core that has cracks but is nevertheless healthy into a core column having a polygon cross-section. This is also shown in FIG. 12a and FIG. 12b. The trapezoid columns have a trapezoid cross-sectional area 6 and form an elongated wedge-frustum. By means of an arrangement as in FIG. 21 it is possible to produce composite panels, which have comparable features like composite panels made of cubic intermediate beams.

In order to compensate the conicity of the boards and planks, as is illustrated in FIG. 14a and FIG. 14b, there is made, e.g., a centrally splitting cut, and the mutually equivalent profiling is used in order to form a rectangular profile. The end side 12 thus gets the more uniform growth ring course neutral to one another. Diagonal branches 30 are of less importance for the rigidity.

FIG. 15, FIG. 15a and FIG. 15b each show mono-layered arrangements of the straight log parts or of boards or planks having edge profiling 23, respectively. In FIG. 15b there is shown the arrangement when a board also obtains a profiling 23a at the side of the core. In FIG. 15a, the arrangement for centrally split boards or planks, respectively, being provided with a profiling 23, is illustrated.

FIG. 16 and FIG. 16b each show two-layered arrangements of the plank or board panel formation also without (FIG. 16) and with an edge profiling 23 (FIG. 16b, following straight board splitting).

FIG. 17a and FIG. 17b finally show in each case three-layered panel formations in a side view. The intermediate composite panel is herein twisted by 90°. This cross-wise arrangement results in optimal rigidities. FIG. 17a shows the end sides 12 in the case of adhesively bonded butt connections that are not centrally split and sorted according to profile (tanner sheet joint). FIG. 17b shows the three-layered panel with centrally split intermediate planks or centrally split intermediate or lateral boards.

A characteristic appearance (texture) of a three-layered panel, as is, e.g., shown in FIG. 17a in a profile view, is shown in FIG. 18. In this picture the composite panel 24 only shows a certain level of parallelism for every other longitudinal groove. Desired crack chamfers 32, as shown in FIG. 18a, are intended to deflect tension at the external surface of the wood composite product 24. Composite panels 21 having desired crack chamfers 32 may each be provided at the opposite, adhesively bonded external surface with an enlarged crack guiding chamfer 33. Tensions later occurring in the visible layer as cracks are in this way guided into the delicately formed visible chamfers, without causing any disturbing visible surface cracks. A so-called deflection of tensions may supplementarily be supported by targeted application of adhesive or by grooves having different widths. In this figure one may recognize at the end sides 12 that the advantageous arrangement of the individual log parts alongside one other parallelizes the course of the growth rings.

In FIG. 19a and FIG. 19b there are examples shown of jointed and tensile-tested boards or planks in a multi-layered construction adhesively bonded to form a flat wood composite product 24a. The wood composite product 24a has a panel depth 26 and a panel width 25 and is split in a determined length from the continuous panel. In the method according to the invention there is preferably provided a general finger jointed connection over the panel width of a layer for boards or planks, with subsequent tensile strength test of the finger joints as well as of the entire composite panel. Fundamentally, this method does also allow for a shorter processing time, such as herein to finger joint with in each case two board widths (split) and then adhesively bond one on top of and next to the other.

In FIG. 19a there is illustrated that there has been omitted profiling close to the tree edge when splitting the log parts, and that there has been used a rather common straight cut. In FIG. 19b the log parts adhesively bonded with each other are at least in part provided with profilings. When adhesively bonding the individual panels the finger joints as well as the joint butts will rest in different areas in regard to the neighbouring boards, thus contributing to an improvement of the stability in total by displacement and overlapping.

In FIG. 20a and FIG. 20b there are depicted in a front view from above three-layered composite panels, wherein also herein there is proposed a cross-wise arrangement between the individual layers. In FIG. 20a there are used centrally split, profiled intermediate planks or lateral boards. In FIG. 20b the used log parts are provided with profiling 23, and they are not jointed, centrally split. The textures at the external surfaces of the wood composite products in FIG. 20a and FIG. 20b differ only slightly, the butts in FIG. 20a showing butt connections that are parallel to the fibres. A continuous general finger jointed connection 11a over the entire wood composite width is markedly obvious.

In FIG. 21 there is depicted a panel connection with trapezoid columns to form an elongated trapezoid column body 8 in an inventive, single-stave tested jointing or general finger jointing over the entire panel width.

FIG. 22 shows in a view from above a tapering, wedge-like intermediate plank 41, as is obtained by a cut line depicted in FIG. 5 or FIG. 5a, respectively. The intermediate plank 41 is split in the direction of the longitudinal axis along cutting planes 18x, 18y each in parallel with the cut surfaces 18a, 18b thereof by cutting out and separating at least an intermediate core wood section 9a in the form of the frustum of a pyramid into two substantially wedge-like intermediate plank parts 9. The two corresponding intermediate plank parts 9 thus obtained, as depicted in FIG. 5c, may then be each positioned into a position in which they correspond with each other as well as are twisted by 180° and/or tilted and are each adhesively bonded flatly at the cut surfaces 18a, 18b with each other to form a composite wood product 10.

The preceding description of the exemplary embodiments according to the present invention is intended only for illustrative purposes and not for the purpose of limiting the invention. In the frame of the invention there are included different changes and modifications, without departing from the scope of the invention or the equivalents thereof.

### REFERENCE LIST

1 round raw wood (from softwood but especially also hardwood)
2 intermediate plank
3 intermediate beam
3a further intermediate beams
3b core beams (halves)
3c round wood sector upon removal of intermediate planks
3d mounting (prism plank on left and right side of the intermediate plank)
4 square cross-section
5 rectangular cross-section
6 symmetrical trapezoid cross-section
7 elongated cuboid body (rectangle prism)
8 elongated trapezoid column body (trapezoid prism)
9 split intermediate plank having a wedge-like tapering cross-section
9a core wood plank having a wedge-like tapering cross-section
10 first wood composite product made of wedge-like intermediate planks
11 finger joint
11a continuous (general) finger joint
12 end side of the log product
13 second wood composite product made of finger jointed wood prisms
14 width of the intermediate beam (or the intermediate plank, resp.)
15 depth (dimension) of the intermediate beam (or the intermediate plank, resp.)
16 growth ring core (growth ring centre)
17 growth ring (segment)
18a, 18b side surfaces of the intermediate planks (intermediate beams) and of the core beam, with section through as many growth rings as possible
18c, 18d side surfaces, as tangential to the growth rings as possible
18e, 18f cutting planes
18g intermediate plank segment having maximum conicity exploitation in tree top position
18h intermediate plank segment, turned, in stump position depicted as profiled
18x, 18y cutting planes
19 crack
20 intermediate planks
20a intermediate plank segment without core area
20b intermediate beam without core area
21 lateral boards
21a lateral boards, intermediate boards having profiling on both sides (also at decaying core course)
22 round wood external surface
23 profiling (trimming)
23a profiling against decaying wood area
24 wood composite product having edge-near profiling and boards (or planks) tapering with board width
24a wood composite product having straight cut profile and boards (or planks) tapering with board width
25 panel width of a cut composite panel
25a girder split from composite panel
26 panel width (also of layered composite panels)
27 relief groove
27a split cut surfaces of centrally split boards or planks
28 formation of rectangular prisms by conical course combination in the opposite direction
29 decaying wood
30 diagonal limb
31 horn knot
32 desired crack chamfer
33 guiding chamfer
34 slab part
35 cut surface (facing the core)
36 cut surface (external, turned away from the core)
37 side surface
38 material depth of the log parts
39 material width of the log parts
40 splitting cut surface
41 wedge-like intermediate plank
42 opening angle
E1 plane of symmetry
T1, T2 tangent plane

1. A method for producing adhesively bonded wood composite products (10, 13, 24, 24a, 25a) from raw logs (1) having substantially the same raw wood length, which wood composite products (10, 13, 24, 24a, 25a) may be connected to form a freely selectable wood composite width and/or a freely selectable wood composite length, characterized by a sequence of the following production steps:
a. splitting each raw log (1) in each case in the longitudinal direction by means of a cutting device alongside cutting planes (18e, 18x, 18y) into log parts having at least five cut surfaces (18a, 18b, 35, 36), wherein there are obtained two outer slab parts (34) as well as several inner log parts, comprising at least one intermediate plank (2) as well as at least two intermediate planks (20) and/or lateral boards (21);
b. preferably producing at least one relief groove (27) by means of a cutting or milling device at the cut surfaces (18a, 18b, 35, 36) of one or of several inner log parts (2, 20, 21), wherein the relief groove (27) is in each case arranged substantially orthogonally to a cut surface (18a, 18b, 35, 36);
c. drying the inner log parts (2, 20, 21) by storing in an evaporation promoting surrounding;
d. levelling preferably all inner log parts (2, 20, 21), wherein the log parts (2, 20, 21) rest with one of the cut surfaces (18a, 35) on a level underground or are extended across thereof and are optionally processed by way of material removal at at least one opposite cut surface (18b, 36) to a predetermined material depth (14, 38);
e. producing a profiling (23) by means of a form cutting device at opposite side surfaces (18c, 18d, 37) of each inner log part (2, 20, 21), wherein the opposite profilings (23) are arranged preferably symmetrically to a plane of symmetry (E1), which plane of symmetry (E1) is oriented substantially orthogonally to the cut surfaces (18a, 18b, 35, 36) as well as centrally of the respective material widths (39);
f. preferably splitting at least one inner log part (2, 20, 32) by applying a splitting cut surface (40) extending substantially in the plane of symmetry (E1) by means of a cutting device, wherein split log parts (3, 20a, 21a) are in each case to be positioned in a position in which they correspond to each other in pairs as well as are mutually rotated/tilted by 180°;
g. sorting log parts (2, 3, 20, 20a, 21, 21a) to be adhesively bonded, wherein not split log parts (2, 20, 21) are arranged alongside one another in a suitable way, in particular by mutually rotating by 180° and/or by moving into tilted positions, so that in each case the planes of symmetry (E1) thereof rest substantially in parallel with one other, and/or already split log parts (3, 20a, 21a) corresponding with each other in pairs are arranged alongside one another in a way so that the splitting cut surfaces (40) thereof rest substantially in parallel with each other;
h. applying adhesives to side surfaces (18c, 18d, 37) provided with profilings (23) of appropriately profiled log parts (2, 20, 21) having the same material depth (38) and/or to splitting cut surfaces (40);
i. adhesively bonding the side surfaces (18c, 18d, 37) provided with adhesive and/or the splitting cut surfaces (30) of log parts (2, 3, 20, 20a, 21, 21a) arranged alongside one another under pressure, preferably under lateral pressure, against the surfaces provided with adhesive, into a wood composite of first quality until the selected wood composite width is exceeded, wherein the wood composite length thereof corresponds to the length of the raw wood;
j. optionally separating a width section of the wood composite by cutting out the width section in the longitudinal direction by means of a cutting device and adhesively bonding the remaining parts of the wood composite alongside one another along the cut surfaces formed by cutting out the width section and optionally adhesively bonding the wood composite with further log parts (2, 3, 20, 20a, 21, 21a) arranged one alongside another into a wood composite of second quality, until the selected wood composite width is again exceeded;
k. trimming the entire wood composite width of the wood composite in the longitudinal direction of the log parts to the selected wood composite width by means of a cutting device;
l. connecting the wood composite with at least one further wood composite, wherein each wood composite has a respective raw wood length and is trimmed in each case to the same wood composite width, wherein in each case following sorting or pre-chopping of unsuitable end areas there are created finger joints (11a) at end sides of each wood composite over the entire wood composite width thereof by means of finger joint milling cutters, wherein there is subsequently applied adhesive at the finger joints and wherein wood composite is repeatedly adhesively bonded to wood composite at the respective finger joints by pressing together until the selected wood composite length is exceeded and wherein the wood composite product (10, 13, 24, 24a, 25a) is obtained by trimming the entire wood composite length to the selected wood composite length transversely to the longitudinal direction of the log parts.

2. A method according to claim 1, characterized in that the wood composite product (10, 13, 24, 24a, 25a) is subjected to a rigidity test, preferably a tensile test by mutual clamping at the end sides of the wood composite and stressing by way of tensile stress by means of a power transmission device in the longitudinal direction of the wood composite product (10, 13, 24, 24a).

3. A method according to claim 2, characterized in that the sections of the wood composite product (10, 13, 24, 24a, 25a), which have damage caused by the rigidity test, preferably by the tensile test, which are visually and/or sensorially detected and which exceed a predetermined level of tolerance, are cut out and separated over the entire wood composite width transversely to the longitudinal direction, whereupon at the cut surfaces there are again arranged finger joints (11a) over the entire wood composite width as well as the remaining undamaged sections are connected with each other at the end sides thereof by adhesive bonding, until there is again reached a predetermined wood composite length, wherein the rigidity test is repeated for the finished wood composite product (10, 13, 24, 24a).

4. A method according to any of claims 1 to 3, characterized in that there is performed a cut for splitting raw log (1) into log parts (2, 20, 21) along parallel cutting planes (18e, 18f), which are substantially in parallel with the longitudinal axis of the raw wood (1), wherein the cut surfaces (18a, 18b, 35, 36) of the log parts (2, 20, 21) are in each case in parallel with one another.

5. A method according to any of claims 1 to 3, characterized in that there is performed a cut for splitting raw log (1) into log parts (20, 21) along cutting planes (18x, 18y), which are substantially in parallel with one of two tangent planes (T1, T2) that are diametrically opposed to one another at the conically tapering round wood external surface (22), wherein the round wood (1) is split, by a first cut in first cutting planes (18x) in parallel with the first tangent plane (T1), starting at the outside, into log parts (20, 21) having cut surfaces (35, 36) that are in parallel with one another up to an intermediate plank, as well wherein the round wood (1) is split by a second cut in second cutting planes (18y) in parallel with a second tangent plane (T2) that is in parallel with a first tangent plane (T1), starting again from the outside, into log parts (20, 21) having cut surfaces (35, 36) that are in parallel with one other up to an intermediate plank, by means of which there is obtained a tapering, wedge-like intermediate plank (41).

6. A method according to claim 5, characterized in that the tapering wedge-like intermediate plank (41) is split in the longitudinal direction along cutting planes (18x, 18y) in each case in parallel with the cut surfaces (18a, 18b) thereof by cutting out and separating at least one central core wood section (9a) substantially in the form of the frustum of a pyramid into two substantially wedge-like intermediate plank parts (9), whereupon the two corresponding intermediate plank parts (9) are each positioned in a position in which they correspond with each other as well as are mutually twisted by 180° and/or tilted and are each adhesively bonded with each other flatly at the cut surfaces (18a, 18b) into a composite wood product (10).

7. A method according to any of claims 1 to 6, characterized in that the profilings (23) are embodied for the inner log parts (2, 20, 21) in the form of two oblique level areas that are substantially symmetrical to the plane of symmetry (E1), which are defined in each case in an opening angle (42) in respect to the split cut surfaces (18a, 18b, 35, 36) in their position, wherein the opening angles (42) of the profilings (23) are selected as close to the perimeter of the round wood external surface (22) as possible and wherein the profilings (23) are formed either by a surface section that is orthogonal to the cut lines (18e) in a longitudinal joint, or by two surface sections that are formed orthogonally to the cut lines (18e) at the side edges (23), wherein the profilings (23) are produced by machining tools, preferably by pulling face cutters or by three rotating circular saw blades.

8. A method according to any of claims 1 to 7, characterized in that in the case of a core defect, for example decaying wood, a hollow trunk or a core crack in the raw log (2) there is split at least an inner log part (2, 20, 21) into two log parts that are each corresponding with each other, wherein there is produced a core-sided profiling (23a) by means of a form cutting device at an internal surface of each split log part (2, 20, 21), wherein this core-sided profiling (23a) is carried out as close to such core defects as possible so that corresponding log parts are supplemented with each other with their outer profiling (23) or their core-sided profiling (23a) as fittingly as possible over the length and in the width at the respective position.

9. A method according to any of claims 1 to 8, characterized in that several different inner log parts (3, 10, 20, 21) of raw log (1) in parallel arrangement to each other and/or adhesively bonded with each other and/or partly adhesively bonded with each other and/or as not adhesively bonded individual parts are each subjected to a rigidity test, preferably a rigidity test for panel-shaped, adhesively bonded wood composite products, wherein a tensile test facility comprising at least two parallel gripers, which are arranged at one or several hydraulic test heads as well as at both end sides of all parallel log parts, may be positioned in a mono-layer, wherein the gripers are provided with clamping jaws having a wood protecting clamp profile.

10. A method according to any of claims 1 to 9, characterized in that several layers of wood composite products (10, 13, 24, 24a, 25a), preferably having the same wood composite lengths and the same wood composite widths, are adhesively bonded in layers one upon the other to form multi-layered wood.

11. A method according to any of claims 1 to 9, characterized in that at least two wood composite products (10, 13, 24, 24a, 25a) are bent and connected with each other to form bent multi-layered panels, in particular forming semi-circular parts, in parallel or flatly off-set, preferably being adhesively bonded with each other.

12. A wood composite product, characterized in that several log parts (2, 3, 6, 20, 21) are adhesively bonded to a mono-layered composite panel at the cut surfaces (18c, 36) facing the core and the cut surfaces (18c, 36) thereof turned away from the core or at the profile areas (23) or split cut surfaces (27a), respectively, wherein the remaining not adhesively bonded side surfaces (18a, 18b, 18e) form the outer main surfaces of the mono-layered composite panel.

13. A wood composite product according to claim 12, characterized by log parts comprising intermediate planks (20), intermediate boards or lateral boards (21) having a constant length, which are connected to form a wood composite width with the same material depth (38), wherein the bonded log parts (20, 21) have square or rectangular cut surface sections at their connecting surfaces, wherein there are visible at the main surfaces or end surfaces of the wood composite product oblique butt joints and/or butt-jointed components having a symmetrical trapezoid form or having a rectangular, if required also bent, trapezoid form.

14. A wood composite product according to any of claim 12 or 13, characterized in that which product has at least one finger joint (11a) running over the entire wood composite width transversely to a fibre direction .

15. A wood composite product according to any of claims 12 to 14, characterized in that inner panel layers are made of multi-layered panels made of log parts that are made of several mono-layered composite panels, which have a lower-quality appearance than the visible external panel layers, wherein hollow spaces in the multi-layered panels are optionally filled with lower-quality wood ingredients and/or with non-wood ingredients.

16. A wood composite product according to any of claims 12 to 15, characterized in that desired crack chamfers (32) are arranged at a visible side of a composite panel and guiding chamfers (33) as power deflection recesses for accommodating tension changes on an opposite side facing the visible side.
